(19) United States
(12) Patent Application Publication
(10) Pub. No.: US 2023/0288288 A1
(43) Pub. Date: Sep. 14, 2023

(54) METHODS AND SYSTEMS FOR DETECTING THE PRESENCE OF AN OPTICAL FIBER

(71) Applicant: RAM Photonics Industrial, LLC, Webster, NY (US)

(72) Inventors: Per Adamson, Conesus, NY (US); Robert Balonek, Rochester, NY (US)

(73) Assignee: RAM Photonics Industrial, LLC, Webster, NY (US)

(21) Appl. No.: 18/119,669

(22) Filed: Mar. 9, 2023

Related U.S. Application Data
(60) Provisional application No. 63/318,050, filed on Mar. 9, 2022.

(51) Int. Cl. G01M 11/00

(52) U.S. Cl. CPC G01M 11/33

(57) ABSTRACT

A system for sensing presence of an optical fiber is provided herein. The system may include a first illumination source configured to emit a first light beam along an optical path and a first detector. The first detector may be positioned off of the optical path and configured to detect a portion of the first light beam refracted through the optical fiber when the optical fiber is disposed perpendicular to the first illumination source and at a first position along the optical path between the first illumination source and the first detector. In some embodiments, the system for sensing the presence of an optical fiber may include a collecting lens. The collecting lens may also be configured to direct the portion of the first light beam refracted through the optical fiber to the first detector when the optical fiber is in the first position.

### CROSS-REFERENCES TO RELATED APPLICATIONS

This application claims the benefit of priority to U.S. Provisional Patent Application No. 63/318,050, filed Mar. 9, 2022, entitled “METHODS AND SYSTEMS FOR DETECTING THE PRESENCE OF AN OPTICAL FIBER,” the entire contents of which are hereby incorporated by reference for all purposes.

### BACKGROUND OF THE INVENTION

Optical fibers have been widely used in optical systems. In some optical systems, multiple optical fibers can be spliced together or an optical fiber can be bonded to an optical element. During the positioning and alignment processes, it may be desirable to detect the presence of an optical fiber. However, due to the small size and transparent nature of optical fibers, detection of the presence of an optical fiber is often difficult. Current systems and techniques do not provide for reliable and consistent detection of optical fibers. Accordingly, there is a need in the art for improved methods and systems related to fiber detection.

### SUMMARY OF THE INVENTION

The present disclosure relates generally to methods and systems related to optical systems including polarization maintaining fibers. More particularly, embodiments of the present invention provide methods and systems that can be used to sense the presence of an optical fiber, for example, during an alignment process. The disclosure is applicable to a variety of applications in lasers and optics, including fiber laser implementations.

A system for sensing presence of an optical fiber is provided herein. The system may include a first illumination source configured to emit a first light beam along an optical axis (also referred to as an optical path) and a first detector. The first detector may be positioned off of the optical axis and configured to detect a portion of the first light beam refracted through the optical fiber when the optical fiber is disposed perpendicular to the first illumination source and at a first position along the optical axis between the first illumination source and the first detector.

In some embodiments, the system for sensing the presence of an optical fiber may include a collecting lens. In such embodiments, the collecting lens may be positioned between the optical fiber and the first detector. The collecting lens may also be configured to direct the portion of the first light beam refracted through the optical fiber to the first detector when the optical fiber is in the first position.

In some embodiments, the system for sensing the presence of an optical fiber may include a second illumination source and a second detector. In such embodiments, the second illumination source may be configured to emit a second light beam and may be positioned at a second position disposed along an axis orthogonal to the optical axis. Additionally, the second detector may be positioned at a third position disposed along the axis orthogonal to the optical axis, and configured to detect refracted light from the second light beam being refracted through the optical fiber when the optical fiber is disposed perpendicular to the second illumination source and between the second illumination source and the second detector in a second position. The second position and the third position may be characterized by an equal distance from the optical axis.

In embodiments including a second detector, the system for sensing the presence of an optical fiber may include a second collecting lens. For example, a second collecting lens may be positioned between the optical fiber and the second detector and configured to direct the refracted light from the optical fiber to the second detector when the optical fiber is in the second position.

A method of detecting an optical fiber is also provided herein. The method may include providing an optical fiber presence sensing system. For example, the optical fiber presence sensing system may include a first illumination source that is configured to emit a light beam, and a first detector. The first detector may be positioned off-axis from the first illumination source and configured to detect the presence of light. The method may also include positioning an optical fiber such that a length of the optical fiber is perpendicular to the first illumination source and emitting, by the first illumination source, a light beam onto at least a portion of the optical fiber. The method may further include detecting, by the first detector, the optical fiber based on the light beam. For example, detecting the optical fiber based on the light beam may include detecting, by the first detector, at least a portion of a refracted beam formed by the light beam refracting through the at least a portion of the optical fiber.

In some embodiments, the optical fiber presence sensing system may further include a second illumination source and a second detector. In such embodiments, the method may further include determining, by the first detector and the second detector, a position of the optical fiber.

Numerous benefits are achieved by way of the present disclosure over conventional techniques. For example, embodiments of the present invention provide methods and systems for detecting the presence of optical fibers that are transparent and small. These and other embodiments of the disclosure, along with many of its advantages and features, are described in more detail in conjunction with the text below and corresponding figures.

### BRIEF DESCRIPTION OF THE DRAWINGS

FIG. 1A is a simplified schematic diagram of an optical fiber presence sensing system according to an embodiment of the present invention.

FIG. 1B illustrates a side view of an optical fiber as provided in the optical fiber presence sensing system illustrated by FIG. 1A.

FIG. 2A is a simplified perspective view diagram illustrating an optical fiber presence sensing system, such as the optical fiber presence sensing system illustrated in FIG. 1A.

FIG. 2B is a simplified plan view diagram illustrating an optical fiber presence sensing system, such as the optical fiber presence sensing system illustrated in FIG. 1A.

FIGS. 3A-C illustrate several operational stages of operating the optical fiber presence sensing system illustrated in FIG. 1A.

FIG. 4 is a simplified schematic diagram of an optical fiber presence sensing system according to another embodiment of the present invention.

FIG. 5 is a simplified flowchart illustrating a method of sensing the presence of an optical fiber using an optical fiber presence sensing system according to an embodiment of the present invention.

### DETAILED DESCRIPTION OF SPECIFIC EMBODIMENTS

The present disclosure relates generally to methods and systems related to optical systems including polarization maintaining fibers. More particularly, embodiments of the present invention provide methods and systems that can be used to detect the presence of a fiber optic cable, also referred to an optical fiber. The disclosure is applicable to a variety of applications in lasers and optics, including fiber laser implementations.

Optical fibers generally have small diameters, such as, for example a diameter of 125 μm or less. Due to its small diameter, detection of an optical fiber during alignment and positioning processes can be difficult. The transparency of the optical fiber also adds to the difficulty of sensing its presence. Conventional detection techniques, such as retro-reflection, direct block, or converging light are inadequate for sensing optical fibers due to the fiber's small diameter and visual transparency. Additionally, optical fibers are not electrically conductive, and thus, electrical current cannot be used for detection purposes. As such, there is a need for improved methods and systems related to detection of the presence of an optical fiber.

To detect optical fibers, an optical fiber presence sensing system and related method of detection are provided herein. The optical fiber presence sensing system, as described below, can detect light that is refracted through an optical fiber. When an optical fiber is present, the refracted light is sensed by the optical fiber presence sensing system and when the optical fiber is not present, the refracted light is not produced, and thus not sensed by the optical fiber presence sensing system. The optical fiber presence sensing system, and related detection methods, provide for a reliable and consistent means of detecting the presence of an optical fiber.

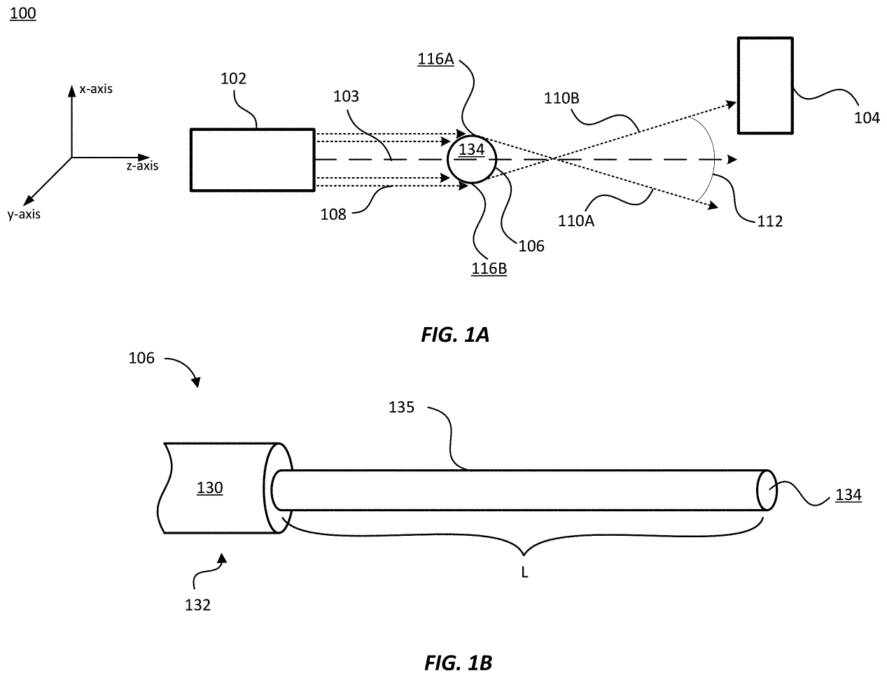

FIG. 1A is a simplified schematic diagram of an optical fiber presence sensing system 100 according to an embodiment of the present invention. As shown, the optical fiber presence sensing system 100 may include an illumination source 102 and a detector 104. The illumination source 102 may be positioned to emit a light beam 108 toward the detector 104 along an optical axis 103. As illustrated in FIG. 1A, the optical axis 103, which can also be referred to as an optical path, is aligned with the z-axis, which can also be referred to as a longitudinal axis. The light beam 108 may be a collimated light beam. The illumination source 102 may include a laser, a light emitting diode (LED), an arc lamp, a fiber optic illuminator, an incandescent source, a fluorescent source, a phosphorescent source, or the like. The detector 104 can be a photodiode, an array of photodiodes, a camera, or the like.

An optical fiber 106 may be positioned along the optical axis 103 between the illumination source 102 and the detector 104. The optical fiber 106 may be a transparent optical fiber. In some embodiments, the optical fiber 106 may include a jacket or coating provided by a manufacturer. In other embodiments, the optical fiber 106 may not include a jacket or coating. The optical fiber 106 may have a diameter that is less than 250 μm. For example, the optical fiber 106 may have a diameter that is less than 225 μm, less than 200 μm, less than 175 μm, less than 150 μm, less than 125 μm, or less than 100 μm. In various embodiments, the optical fiber may be a polarization maintaining fiber. For example, the optical fiber may be or include bow-tie fibers, panda fibers, multi-core fibers, elliptical fibers, photonic crystal optical fibers, and the like.

The optical fiber 106 may be positioned along the optical axis 103 such that the light beam 108 illuminates at least a portion of the optical fiber 106. In the embodiment illustrated in FIG. 1A, the optical fiber 106 is positioned along the optical axis 103 in a centered configuration such that the light beam 108 illuminates the optical fiber 106 over the entire diameter of the optical fiber 106. In FIG. 1A, the diameter of the light beam 108 and the diameter of the optical fiber 106 are equal, but this is not required and in other embodiments, the diameter of the light beam 108 is less than the diameter of the optical fiber 106 or the diameter of the light beam 108 is greater than the diameter of the optical fiber 106. Moreover, although the optical fiber 106 is centered on the origin of the x-z axes, the optical fiber 106 may be positioned at a location with a positive or negative z-position as well as a positive or negative x-position as long as an overlap exists between the light beam 108 and the optical fiber 106. One of ordinary skill in the art would recognize many variations, modifications, and alternatives.

For ease of discussion, FIG. 1B is provided to illustrate a side view of the optical fiber 106 as provided in the optical fiber presence sensing system 100. As shown by FIG. 1B, the optical fiber 106 may include a fiber body 132 and a fiber core/cladding 135. The fiber core/cladding 135 can terminate at an emission face 134. The fiber body 132 includes a jacket 130 surrounding the fiber core/cladding 135 in the fiber body 132. Light is emitted from emission face 134 during operation of the optical fiber 106.

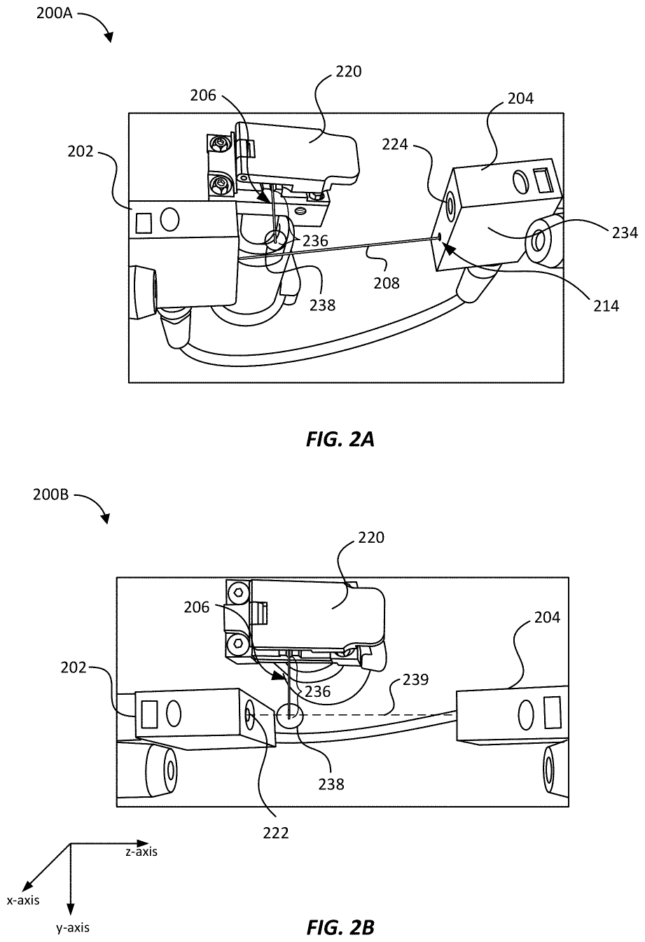

For the optical fiber 106 illustrated in FIG. 1B, the fiber core/cladding 135 is characterized by a length L. As described more fully in relation to FIGS. 2A and 2B, the fiber core/cladding 135 can be disposed in the optical fiber presence sensing system 100 such that the fiber core/cladding 135 of the optical fiber 106 can be positioned with the length L perpendicular to the optical axis 103 corresponding to the light beam 108 emitted by the illumination source 102. The length L of the fiber core/cladding 135 of the optical fiber 106, and the position of the optical fiber 106 with respect to the illumination source 102 is described in greater detail with respect to FIGS. 2A and 2B.

Referring once again to FIG. 1A, the optical fiber 106 may be positioned along the optical axis 103 of the light beam 108 as emitted by the illumination source 102. In FIGS. 1A and 1B, the fiber core/cladding 135 extends along the y-axis, which is collinear with the optical axis 103. In other embodiments, the optical fiber 106 may be positioned such that portions of the light beam 108 refract through at least a portion of the fiber core/cladding 135 of the optical fiber 106. For example, the light beam 108 may refract through one or both of a first side 116A of the optical fiber 106 (i.e., the top half cylinder portion of the optical fiber) and a second side 116B of the optical fiber 106 (i.e., the bottom half cylinder portion of the optical fiber).

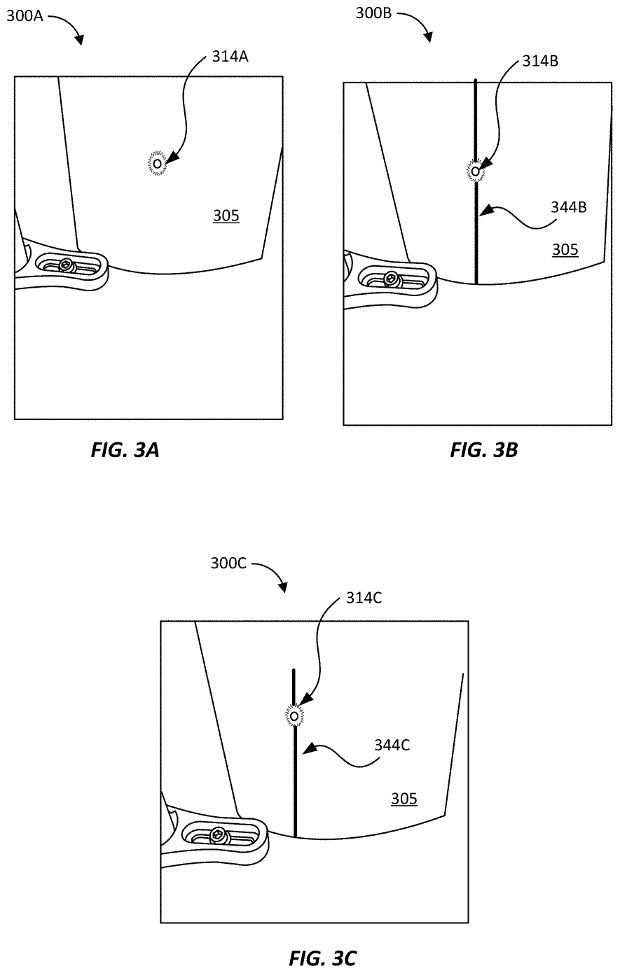

Due to the cylindrical nature of the fiber core/cladding 135 of the optical fiber 106, the light beam 108 refracts through the first side 116A and the second side 116B of the optical fiber 106 to form first refracted beam 110A and the second refracted beam 110B. First refracted beam 110A and second refracted beam 110B are understood to include the light beams refracted at the angles in angular range 112 between the first refracted beam 110A and the second refracted beam 110B. Because the first refracted beam 110A and the second refracted beam 110B are refracted through the optical fiber 106, which acts as a cylindrical lens, the first refracted beam 110A and the second refracted beam 110B may form a vertical line along the angular range 112 that is perpendicular to the length of the optical fiber 106. The width of the vertical line will be equal to the width (measured along the y-axis) of the light beam 108. In some embodiments, the width of the vertical line may also depend on a distance from the illumination source 102 and the divergence of the first refracted beam 110A and the second refracted beam 110B. The vertical line (aligned with the x-axis) formed along the angular range 112 is discussed in greater detail below with reference to FIGS. 3A-3C.

To detect the presence of the optical fiber 106, the detector 104 may be positioned off-axis from the light beam 108 emitted by the illumination source 102. In other words, the detector 104 may be positioned off of the optical axis 103. Positioning the detector 104 off-axis may mean positioning the detector 104 either at a predetermined distance along the x-axis above or below the illumination source 102. Since the detector 104 can be in alignment with the illumination source 102 in the x-z plane (i.e., not displaced along the y-axis), the detector 104 will receive light refracted through the optical fiber and, therefore, be able to detect the presence of the optical fiber 106 as a result of refraction of the light beam 108 by the optical fiber 106. Although the detector 104 in FIG. 1A is oriented perpendicular to the optical fiber 106, in some embodiments, the detector 104 may be tilted toward the optical fiber 106.

By positioning the detector 104 off of the optical axis of the light beam 108 emitted by the illumination source 102, the detector 104 may only receive and thereby detect a portion of the vertical line formed by the first refracted beam 110A and the second refracted beam 110B. Since the first refracted beam 110A and the second refracted beam 110B are formed as a result of refraction by the optical fiber 106, if the optical fiber 106 is not present, then the first refracted beam 110A and the second refracted beam 110B are not formed, and the optical fiber 106 is not sensed.

It should be understood that in some embodiments, if the optical fiber 106 is positioned such that its length is aligned with the x-axis rather than the y-axis, then the first refracted beam 110A and the second refracted beam 110B may form a horizontal line along the y-axis instead of a vertical line along the x-axis. In such cases, the detector 104 may be positioned off-axis along the x-axis such that at least a portion of the horizontal line impinges on the detector 104.

FIG. 2A is a simplified perspective view diagram illustrating an optical fiber presence sensing system, such as the optical fiber presence sensing system illustrated in FIG. 1A. FIG. 2B is a simplified plan view diagram illustrating an optical fiber presence sensing system, such as the optical fiber presence sensing system illustrated in FIG. 1A.

Referring to FIGS. 2A and 2B, a perspective view diagram 200A and a plan view 200B of an optical fiber presence sensing system, such as the optical fiber presence sensing system 100 illustrated in FIG. 1A, are provided. As shown, the optical fiber presence sensing system depicted in perspective view diagram 200A includes an illumination source 202 and a detector 204. The illumination source 202 and the detector 204 may be the same or similar to the illumination source 102 and the detector 104 as described above with respect to FIG. 1A. Accordingly, the description provided in relation to FIGS. 1A and 1B is applicable to FIGS. 2A and 2B as appropriate.

As shown, an optical fiber 206 may be positioned between the illumination source 202 and the detector 204. The optical fiber 206 may be positioned using a positioner 220. The positioner 220 may be part of the optical fiber presence sensing system and may be configured to hold the optical fiber 206 in a predetermined position. In some embodiments, the positioner 220 may be a clamp. In other embodiments, the positioner 220 may be an optical fiber stage or platform containing a v-groove that holds the optical fiber 206 in a predetermined position. In still further embodiments, the positioner 220 may include one or more rolling guides supporting and/or directing an optical fiber 106. For example, the optical fiber 106 may be moved using the positioner 220 such that it is positioned to be in the path of the light beam 108. Those skilled in the art would readily appreciate the various configurations of the positioner 220.

The optical fiber 106 may be positioned such that a length 236 of the optical fiber 206 is perpendicular to a light beam being emitted or transmitted from the illumination source 202 to the detector 204. The optical fiber 206 may also be positioned such that a light beam emitted from the illumination source 102 illuminates at least a portion of the optical fiber 206. As depicted by region 238, an end portion of the optical fiber 206 is illuminated by a light beam emitted by (i.e., transmitted from) the illumination source 202.

Referring now to FIG. 2B, a plan view 200B of the optical fiber presence sensing system 100 shown in FIG. 1A is depicted in a perspective view diagram 200A. As shown by plan view 200B, the illumination source 202 may include an emitter 222 of the illumination source 202 from which the light beam 208 is emitted. In embodiments, the optical fiber 206 may be supported by the positioner 220 such that the length 236 of the optical fiber 206 may be oriented in a direction that is perpendicular to the optical axis of a light beam 208 that is emitted from the emitter 222. In other embodiments, the optical fiber 206 may be oriented in a direction that is angled with respect to the optical axis of a light beam 208 that is emitted from the emitter 222. Although the optical fiber 206 may be supported by the positioner 220 such that the length 236 of the optical fiber 206 is oriented in a direction that is perpendicular to the optical axis of a light beam 208 as emitted from the emitter 222, i.e., the length 236 of the optical fiber 206 is aligned with the y-axis, the optical fiber 206 may be positioned at a position along the x-axis such that the optical fiber 206 does not lie in the same plane as the light beam 208, i.e., the y-z plane. Additionally, the optical fiber 206 may be supported by the positioner 220 such that the length 236 of the optical fiber 206 is oriented in a direction that is perpendicular to the optical axis of a light beam 208 as emitted from the emitter 222, i.e., the length 236 of the optical fiber 206 is aligned with the y-axis, but the optical fiber 206 may be positioned at a position along the y-axis such that the optical fiber 206 does not extend far enough along the y-axis to refract the light beam 208.

Accordingly, the optical fiber 206 may also be placed on the same plane as the emitter 222 and the light beam 208 as well as at a position along the y-axis such that the light beam 208 emitted from the emitter 222 is directed onto at least a portion of the optical fiber 206, as indicated by the region 238 shown in FIG. 2B.

The light beam 208 emitted from the emitter 222 of the illumination source 202 may be transmitted along the optical path 239 and impinge on the detector 204. Specifically, the light beam 208 emitted by the illumination source 202 may impinge on a case 234 of the detector 204. As shown by FIG. 2A, which illustrates the condition in which the optical fiber 206 is not present in the fiber presence sensing system, the light beam is visible on the case 234 of the detector 204 at contact point 214. In this example, since the optical fiber 206 is not present along the optical path 239, the light beam 208 emitted by the emitter 222 of the illumination source 202 does not interact with the optical fiber 206 and the light beam 208 impinges on the case 234 of the detector 204 at the contact point 214 after free space propagation from the emitter 222 of the illumination source 202.

The detector 204 may also include a sensor 224. When the optical fiber 206 is not present as illustrated in FIG. 2B, the light beam 208 emitted from the emitter 222 of the illumination source 202 will be undisturbed as it propagates along optical path 239, impinging on the case 234 of the detector 204 at the contact point 214. As a result, the signal measured at the sensor 224 will be negligible or zero.

When the optical fiber 206 is supported by the positioner 220 such that the length 236 of the optical fiber 206 is oriented in a direction that is perpendicular to the optical axis of a light beam 208 as emitted from the emitter 222, i.e., the length 236 of the optical fiber 206 is aligned with the y-axis, the optical fiber 206 is positioned at a position along the y-axis such that the optical fiber 206 crosses the optical path 239, and the optical fiber 206 is positioned at a position along the x-axis such that the optical fiber 206 lies in the same plane as the light beam 208, i.e., the y-z plane, the light beam 208 emitted by the emitter 222 of the illumination source 202 will interact with the optical fiber 206. In some cases, the length 236 of the optical fiber 206 does not have to be aligned with the y-axis and the optical fiber 206 can be positioned at a position along the y-axis such that the optical fiber 206 crosses the optical path 239 and the optical fiber 206 can be positioned at a position along the x-axis such that the optical fiber 206 lies in the same plane as the light beam 208, thereby resulting in the light beam 208 emitted by the emitter 222 of the illumination source 202 interacting with the optical fiber 206.

As discussed more fully in relation to FIGS. 3B and 3C, the optical fiber 206 can be positioned at a position intersecting with the light beam 208, i.e., the optical fiber can be present in the optical fiber presence sensing system 100 illustrated in FIG. 1A along optical path 239, such that the light beam 208 emitted by the emitter 222 of the illumination source 202 will be refracted by the optical fiber 206 and propagate through the optical fiber 206, which will act as a cylindrical lens, resulting in the light beam 208 being refracted to form a vertical line (aligned with the x-direction) due to this refraction. The vertical line produced as a result of refraction of the light beam 208 by the optical fiber 206 may extend vertically (i.e., along the x-axis) from the contact point 214 on the case 234 of the detector 204 toward the sensor 224 of the detector 204. Thus, when the optical fiber is present in the optical fiber presence sensing system along optical path 239, the sensor 224 will sense light present in the vertical line produced as a result of refraction of the light beam 208 by the optical fiber 206, indicating the presence of the optical fiber in the optical fiber presence sensing system.

As illustrated in FIG. 2A, the sensor 224 of the detector 204 is positioned off-axis with respect to the illumination source 202. In other words, the sensor 224 of the detector 204 is located at a position above the y-z axis such that the light beam 208 impinges on the case 234 of the detector 204 at a position below the sensor 224. As a result, the sensor 224 is displaced with respect to the contact point 214, which corresponds to the position at which the light beam 208 impinges on the case 234 of the detector 204 in the absence of the optical fiber. Thus, by positioning the sensor 224 of detector 204 off-axis with respect to the optical path 239, in this embodiment, at a predetermined position along the x-axis, the sensor 224 will only receive light corresponding to the vertical line extending along the x-axis when the refracted beams are formed as a result of the presence of the optical fiber 206.

FIGS. 3A-3C illustrate several operational stages of operating the optical fiber presence sensing system illustrated in FIG. 1A. In particular, FIGS. 3A-3C provide a first image 300A, a second image 300B, and a third image 300C, respectively, of a contact point of a light beam received by a detector of the optical fiber presence sensing system illustrated in FIG. 1A. The light beam 108 illustrated in FIG. 1A may be produced by an illumination source, such as the illumination source 102 illustrated in FIG. 1A or the illumination source 202 illustrated in FIG. 2A.

Referring to FIG. 3A, the first image 300A includes a contact point 314A that is formed on a screen 305 for a straight through control condition. In the straight through control condition, the optical fiber is not present in the optical fiber presence sensing system as discussed above. As shown in FIG. 3A, the contact point 314A included in the first image 300A does not include a vertical line. Instead, the contact point 314A is a circular point. The contact point 314A may be produced by the impingement of the light beam 108 shown in FIG. 1A on the case of the detector, i.e., as it is received at the detector, for example, the detector 104 or the detector 204, when there is no optical fiber present in the optical fiber presence sensing system.

Referring to FIG. 3B, the second image 300B includes a contact point 314B that is formed on a screen 305 for a condition in which an optical fiber is present in the optical fiber presence sensing system and the optical fiber is sensed using the optical fiber presence sensing system. The optical fiber may be the same or similar to the optical fiber 106 illustrated in FIG. 1A or the optical fiber 206 illustrated in FIG. 2A. The contact point 314B is no longer a circular point, but has expanded to form a vertical line 344B. The vertical line 344B may extend vertically through and beyond the contact point 314B on one or both sides of the vertical line 344B. As discussed above, the vertical line 344B may be formed by light beams refracted through the optical fiber as they impinge on screen 305. Considering the optical fiber along the axial direction of the optical fiber (i.e., along the y-axis as illustrated in FIG. 1A), the shape of the fiber will correspond to a cylindrical lens. In the horizontal direction in FIG. 3B (i.e., along the y-axis as illustrated in FIG. 1A), the light passes through the optical fiber, but experiences no focusing since the axial direction of the fiber is aligned with the horizontal direction. However, in the vertical direction (i.e., along the z-axis), the optical fiber will act as a cylindrical lens, focusing the incident light beam at a focus point between the position of the optical fiber and location of the screen 305, then diverging to form vertical line 344B on screen 305. Thus, the vertical line 344B is formed when the optical fiber is present in the optical fiber presence sensing system. To detect the presence of the optical fiber, the sensor of the detector may sense at least a portion of the light forming the vertical line 344B, as discussed above.

The vertical line 344B may form perpendicular to the length of the optical fiber. For example, returning to FIG. 2A, if a vertical line 344B was formed in response to the presence of the optical fiber 206 in the optical fiber presence sensing system, the vertical line 344B would form vertically on the case 234 of the detector 204, extending along the x-direction from the contact point 214 to the sensor 224.

The optical fiber presence sensing system can also detect an optical fiber when the optical fiber is not transparent. For example, the optical fiber may be coated, have a covering, or be made from non-transparent materials. To demonstrate the detection capabilities of the optical fiber presence sensing system, an optical fiber was blackened. Referring now to FIG. 3C, the third image 300C includes a contact point 314C for the blackened optical fiber. As shown, the contact point 314C formed on screen 305 includes a reduced intensity vertical line 344C. The reduced intensity vertical line 344C extends vertically through and beyond the contact point 314C. The reduced intensity vertical line 344C may be shorter (e.g., extend along the x-axis by a reduced distance beyond the contact point 314C) than the vertical line 344B because the optical fiber present in the optical fiber presence sensing system corresponding to FIG. 3C is not transparent. However, as illustrated in FIG. 3C, even optical fibers having non-transparent materials may be detected by embodiments of the present invention. As those skilled in the art would recognize, in the case where the optical fiber is non-transparent, the optical mechanism may be diffraction instead of refraction.

In some embodiments, there may be more than one illumination source and more than one detector.

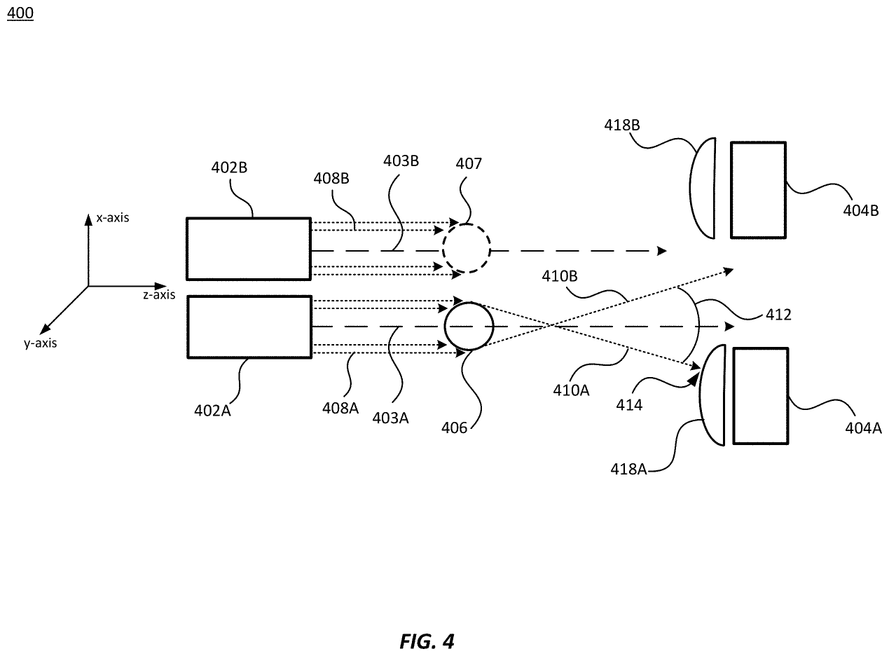

FIG. 4 is a simplified schematic diagram of an optical fiber presence sensing system according to another embodiment of the present invention. Referring to FIG. 4, an optical fiber presence sensing system 400 is illustrated, according to an embodiment herein. As shown, the optical fiber presence sensing system 400 may include a first illumination source 402A and a second illumination source 402B. The first illumination source 402A and the second illumination source 402B may be the same or similar to the illumination source 102 illustrated in FIG. 1A. The optical fiber presence sensing system 400 may allow for detection of a position of an optical fiber when disposed in the optical fiber presence sensing system 400.

The optical fiber presence sensing system 400 may also include a first detector 404A and a second detector 404B. The first detector 404A and the second detector 404B may be the same or similar to the detector 104 illustrated in FIG. 1A. The first illumination source 402A may be configured to emit a first light beam 408A towards the first detector 404A. The first light beam 408A is centered on first optical axis 403A. The second illumination source 402B may be configured to emit a second light beam 408B towards the second detector 404B. The second light beam 408B is centered on second optical axis 403B. The first detector 404A may be positioned off-axis with respect to the first light beam 408A produced by the first illumination source 402A. In other words, the first detector 404A may be positioned along the x-axis at an x-position separated from the x-position along the x-axis where the first light beam 408A is located. Thus, the first detector 404A is off-axis with respect to first light beam 408A produced by the first illumination source 402A.

Similarly, the second detector 404B may be positioned off-axis from the second illumination source 402B. In the embodiment illustrated in FIG. 4, the second detector 404B is positioned at a greater x-position than the position of the second optical axis 403B on which second light beam 408B is centered. The first detector 404A and the second detector 404B may be positioned such that each detector can only receive a vertical line formed by refracted beams formed from a respective light beam, i.e., first light beam 408A and second light beam 408B, respectively. For example, the first detector 404A may be positioned to only receive light from a vertical line formed by refracted beams produced as a result of the interaction of the first light beam 408A with the optical fiber 406, and the second detector 404B may be positioned to only receive light from a vertical line formed by refracted beams produced as a result of the interaction of the second light beam 408B with the optical fiber 406 positioned in the optional second position 407.

In some embodiments, the first illumination source 402A and the second illumination source 402B may be configured to emit different wavelengths. In such embodiments, the first detector 404A and the second detector 404B may be configured to detect the wavelength of the respective illumination source, i.e., the first illumination source 402A and the second illumination source 402B, respectively. Although the present example illustrated in FIG. 4 illustrates two illumination sources and two detectors, it should be appreciated that any number of illumination sources and/or detectors may be used. One of ordinary skill in the art would recognize many variations, modifications, and alternatives.

As shown, an optical fiber 406 may be disposed between the first illumination source 402A and the first detector 404A. The optical fiber 406 may be the same or similar to the optical fiber 106 illustrated in FIG. 1A or the optical fiber 206 illustrated in FIG. 2A. The optical fiber 406 may be positioned such that a length of the optical fiber 406 is perpendicular to the first light beam 408A emitted by the first illumination source 402A. Similarly, the optical fiber 406 may be positioned in the optional second position 407 such that a length of the optical fiber 406 positioned in the optional second position 407 is perpendicular to the second light beam 408B emitted by the second illumination source 402B.

The optical fiber presence sensing system 400 may allow for the optical fiber 406 to be sensed in more than one position. For example, when the optical fiber 406 is positioned in a first position, as illustrated in FIG. 4, the first detector 404A may detect the presence of the optical fiber 406. When the optical fiber 406 is positioned in an optional second position 407, the second detector 404B may detect the presence of the optical fiber 406 in this optional second position 407.

To sense the optical fiber 406 in the first position as illustrated in FIG. 4, the first light beam 408A may be emitted onto at least a portion of the length of the optical fiber 406. As discussed above, due to the cylindrical nature of the length of the optical fiber 406, the first light beam 408A may be refracted by the optical fiber to form the first refracted beam 410A and the second refracted beam 410B. The first refracted beam 410A and the second refracted beam 410B are understood to include refracted beams at angles within the angular range 412. The first refracted beam 410A and the second refracted beam 410B may form a vertical line, such as vertical line 344B depicted in FIG. 3B. A portion of the vertical line formed by the first refracted beam 410A and the second refracted beam 410B may be received by the first detector 404A at point 414. Based on receiving a portion of the vertical line formed by the first refracted beam 410A and the second refracted beam 410B, the first detector 404A may detect the presence of the optical fiber 406 in the first position. In embodiments where the optical fiber 406 is in the optional second position 407, the second detector 404B may detect the presence of the optical fiber 406 in the optional second position 407 via a similar technique.

In some embodiments, the optical fiber presence sensing system 400 may include one or more collecting lenses. For example, a first collecting lens 418A may be positioned in front of the first detector 404A. In other words, the first collecting lens 418A may be positioned between the optical fiber 406 and the first detector 404A. A second collecting lens 418B may be similarly positioned in front of the second detector 404B. The first collecting lens 418A may be positioned to capture at least a portion of the first refracted beam 410A and the second refracted beam 410B and direct the first refracted beam 410A and the second refracted beam 410B towards the first detector 404A. Similarly, the second collecting lens 418B may be positioned to capture at least a portion of light refracted by the optical fiber 406 when disposed in the optional second position 407, and direct the refracted light to the second detector 404B. In some embodiments, the first collecting lens 418A and/or the second collecting lens 418B may include a folding mirror or beam splitter. Depending on the configuration of the optical fiber presence sensing system 400, a collecting lens, a folding mirror, or a beam splitter may be used to direct the first refracted beam 410A and the second refracted beam 410B to the first detector 404A and/or the second detector 404B.

As noted above, the first detector 404A and the second detector 404B may each be positioned off-axis from a respective illumination source. As shown in FIG. 4, the second detector 404B may be off-axis from the second illumination source 402B such that the second light beam 408B is not received by the second detector 404B when the optical fiber 406 is not present in the optional second position 407. The second detector 404B may also be positioned to not receive either the first refracted beam 410A or the second refracted beam 410B that may be refracted from the optical fiber 406 when the optical fiber 406 is in the first position illustrated in FIG. 4. Similarly, the first detector 404A may be positioned off-axis from the first illumination source 402A to not receive the first light beam 408A when the optical fiber 406 is not in the first position illustrated in FIG. 4. Additionally, the first detector 404A may be positioned to not receive light from the second light beam 408B that is refracted by the optical fiber 406 when the optical fiber is in the optional second position 407. One example of positions for the first detector 404A and the second detector 404B may be that the first detector 404A is positioned off-axis along the x-axis below the first illumination source 402A and the second detector 404B may be positioned off-axis along the x-axis above the second illumination source 402B.

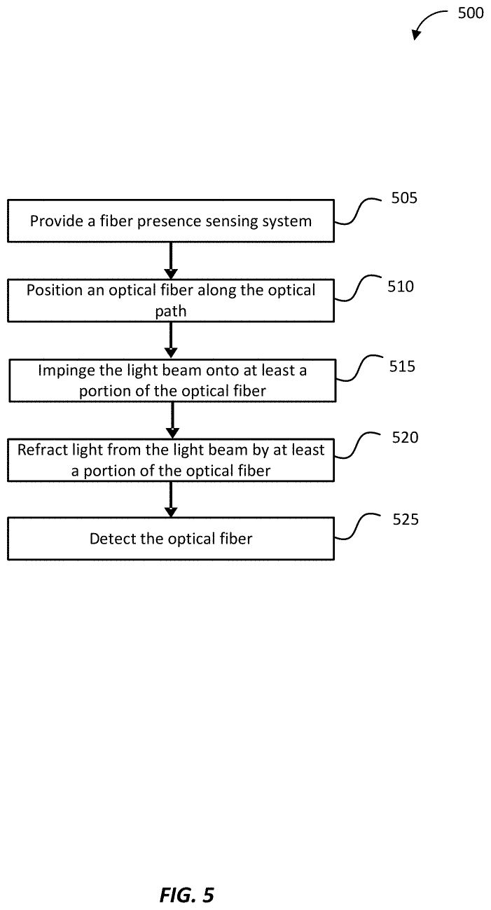

FIG. 5 is a simplified flowchart illustrating a method of sensing the presence of an optical fiber using an optical fiber presence sensing system according to an embodiment of the present invention. For ease of discussion, the method 500 illustrated in FIG. 5 is described with reference to FIG. 1A; however, it should be understood that any systems or techniques described herein may be applicable.

The method 500 of sensing the presence of an optical fiber using an optical fiber presence sensing system includes providing the optical fiber presence sensing system (505). The optical fiber presence sensing system, for example, optical fiber presence sensing system 100, includes a first illumination source that is configured to emit a light beam along an optical path. For example, the first illumination source may be a laser or an LED. The light beam can be emitted along an optical path aligned with an optical axis of the first illumination source. The optical fiber presence sensing system may also include a first detector, such as the detector 104 illustrated in FIG. 1. The detector may be positioned off-axis with respect to the optical path along which the light beam emitted from the first illumination source propagates, as illustrated in FIG. 1A, and be configured to detect the presence of light.

The method 500 also includes positioning an optical fiber along the optical path (510). In some embodiments, the optical fiber is positioned such that the length of the optical fiber is perpendicular to the optical path along which the light beam emitted by the first illumination source propagates. The optical fiber, for example optical fiber 106 illustrated in FIG. 1A, may be positioned such that its length, L, is perpendicular to the optical path of the light beam emitted by the first illumination source.

The method 500 further includes impinging the light beam onto at least a portion of the optical fiber (515). For example, the first illumination source may emit a light beam 108 that impinges on the optical fiber 106, as illustrated in FIG. 1A.

The method 500 additionally includes refracting light from the light beam by at least a portion of the optical fiber (520). As illustrated in FIG. 1A, first refracted beam 110A and second refracted beam 110B are produced as light beam 108 is refracted by optical fiber 106. The method also includes detecting, based at least in part on the refracted beam and using the first detector, the optical fiber (525). For example, the optical fiber presence sensing system 100 may detect the optical fiber 106 based on the first refracted beam 110A or the second refracted beam 110B. In some embodiments, detecting the optical fiber may further include detecting, using the first detector, at least a portion of a refracted beam. For example, the detector 104 may detect one or both of the first refracted beam 110A and the second refracted beam 110B. As described above, the first refracted beam 110A and the second refracted beam 110B may be formed by refracting through a portion of the optical fiber 106.

In some embodiments, the optical fiber presence sensing system 100 may further include a second illumination source and a second detector. In such embodiments, the method 500 may further include determining, using the first detector and the second detector, a position of the optical fiber. For example, as illustrated by FIG. 4, the position of the optical fiber 406 may be determined by the first detector 404A and the second detector 404B.

It should be appreciated that the specific steps illustrated in FIG. 5 provide a particular method of detecting an optical fiber according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

The examples and embodiments described herein are for illustrative purposes only. Various modifications or changes in light thereof will be apparent to persons skilled in the art. These are to be included within the spirit and purview of this application, and the scope of the appended claims, which follow.

What is claimed is:

1. A system for sensing presence of an optical fiber, the system comprising:
a first illumination source configured to emit a first light beam along an optical path; and
a first detector, wherein the first detector is:
positioned off of the optical path; and
configured to detect a portion of the first light beam refracted through the optical fiber when the optical fiber is disposed perpendicular to the first illumination source and at a first position along the optical path between the first illumination source and the first detector.

2. The system of claim 1, further comprising a collecting lens, wherein the collecting lens is:
positioned between the optical fiber and the first detector; and
configured to direct the portion of the first light beam refracted through the optical fiber to the first detector when the optical fiber is in the first position.

3. The system of claim 2, further comprising a second illumination source and a second detector, wherein:
the second illumination source is:
configured to emit a second light beam; and
positioned at a second position disposed along a second optical path orthogonal to the optical path; and
the second detector is:
positioned at a third position disposed along the second optical path; and
configured to detect refracted light from the second light beam being refracted through the optical fiber when the optical fiber is disposed perpendicular to the second illumination source and between the second illumination source and the second detector in the second position.

4. The system of claim 3, further comprising:
a second collecting lens, wherein the second collecting lens is:
positioned between the optical fiber and the second detector; and
configured to direct the refracted light from the optical fiber to the second detector when the optical fiber is in the second position.

5. The system of claim 3, wherein the second position and the third position are characterized by an equal distance from the optical path.

6. The system of claim 3, wherein:
the first illumination source comprises a first laser;
the first detector comprises a first photodiode;
the second illumination source comprises a second laser; and
the second detector comprises a second photodiode.

7. The system of claim 1 wherein the first illumination source comprises a laser.

8. The system of claim 1 wherein the first detector comprises a photodiode.

9. A method of detecting an optical fiber, the method comprising:
providing an optical fiber presence sensing system comprising:
a first illumination source configured to emit a light beam along an optical path; and
a first detector, wherein the first detector is:
positioned off-axis with respect to the optical path; and
configured to detect the presence of light;
positioning an optical fiber along the optical path;
impinging the light beam onto at least a portion of the optical fiber;
refracting light from the light beam by at least a portion of the optical fiber to produce a refracted beam; and
detecting, based at least in part on the refracted beam and using the first detector, the optical fiber.

10. The method of claim 9 wherein detecting the optical fiber comprises detecting, using the first detector, at least a portion of the refracted beam.

11. The method of claim 9 wherein the optical fiber presence sensing system further comprises a second illumination source and a second detector.

12. The method of claim 11 further comprising determining, using the first detector and the second detector, a position of the optical fiber.

13. The method of claim 9 wherein a length of the optical fiber is perpendicular to the optical path.
